(19) United States
(12) Patent Application Publication
(10) Pub. No.: US 2021/0073912 A1
(43) Pub. Date: Mar. 11, 2021

(54) SYSTEM AND METHOD FOR UNCERTAINTY-BASED ADVICE FOR DEEP REINFORCEMENT LEARNING AGENTS

(71) Applicant: ROYAL BANK OF CANADA, Toronto (CA)

(72) Inventors: Felipe Leno DA SILVA, São Paulo (BR); Pablo Francisco HERNANDEZ LEAL, Edmonton (CA); Bilal KARTAL, Edmonton (CA); Matthew Edmund TAYLOR, Edmonton (CA)

(21) Appl. No.: 17/011,310

(22) Filed: Sep. 3, 2020

Related U.S. Application Data
(60) Provisional application No. 62/896,362, filed on Sep. 5, 2019.

(51) Int. Cl. G06Q 40/04; G06N 3/08; G06N 3/04

(52) U.S. Cl. CPC G06Q 40/04; G06N 3/04; G06N 3/08

(57) ABSTRACT

Disclosed are systems, methods, and devices for training a learning agent. A learning agent that maintains a reinforcement learning neural network is instantiated. State data reflective of a state of an environment explored by the learning agent is received. An uncertainty metric calculated upon processing the state data, the uncertainty metric measuring epistemic uncertainty of the learning agent. Upon determining that the uncertainty metric exceeds a pre-defined threshold: a request signal requesting an action suggestion from a demonstrator is sent; a suggestion signal reflective of the action suggestion is received; and an action signal to implement the action suggestion is sent.

### CROSS-REFERENCE TO RELATED APPLICATIONS

This application claims all benefit including priority to U.S. Provisional Patent Application 62/896,362, filed Sep. 5, 2019, and entitled “SYSTEM AND METHOD FOR UNCERTAINTY-BASED ADVICE FOR DEEP REINFORCEMENT LEARNING AGENTS”; the entire contents of which are hereby incorporated by reference herein.

### FIELD

This disclosure relates to artificial intelligence, and more specifically to deep reinforcement learning agents.

### BACKGROUND

Although reinforcement learning has been one of the most successful approaches for learning in sequential decision making problems, the sample-complexity of reinforcement learning techniques still represents a major challenge for practical applications.

### SUMMARY

In accordance with one aspect, there is provided a computer-implemented system for training a learning agent. The system includes: at least one processor; memory in communication with the at least one processor, and software code stored in the memory. The software code when executed by the at least one processor causes the system to: instantiate a learning agent that maintains a reinforcement learning neural network; receive state data reflective of a state of an environment explored by the learning agent; calculate an uncertainty metric upon processing the state data, the uncertainty metric measuring epistemic uncertainty of the learning agent, and upon determining that the uncertainty metric exceeds a pre-defined threshold: send a request signal requesting an action suggestion from a demonstrator; receive a suggestion signal reflective of the action suggestion; and send an action signal to implement the action suggestion.

In accordance with another aspect, there is provided a computer-implemented method for training a learning agent. The method includes: instantiating a learning agent that maintains a reinforcement learning neural network; receiving state data reflective of a state of an environment explored by the learning agent; calculating an uncertainty metric upon processing the state data, the uncertainty metric measuring epistemic uncertainty of the learning agent; upon determining that the uncertainty metric exceeds a pre-defined threshold: sending a request signal requesting an action suggestion from a demonstrator; receiving a suggestion signal reflective of the action suggestion; and sending an action signal to implement the action suggestion.

In accordance with another method, there is provided a computer-implemented method for determining epistemic uncertainty of a learning agent. The method includes maintaining a neural network comprising a plurality of hidden layers including a layer having a plurality of heads, each of the heads generating predictions of action values for actions that can taken by the learning agent; for a given state of an environment explored by the learning agent: receiving, from each of the plurality of heads, a predicted action value; and computing a variance of the predicted action values received from the plurality of heads.

Many further features and combinations thereof concerning embodiments described herein will appear to those skilled in the art following a reading of the instant disclosure.

### DESCRIPTION OF THE FIGURES

In the figures,

FIG. 1 is a schematic diagram of a training system, in accordance with an embodiment;

FIG. 2 is a schematic diagram of a learning agent, in accordance with an embodiment;

FIG. 3A shows an RCMP algorithm as implemented by a learning agent of FIG. 2, in accordance with an embodiment;

FIG. 3B shows an implementation of a DQN with heads, in accordance with an embodiment;

FIG. 4A is a schematic diagram of a conventional DQN;

FIG. 4B is a schematic diagram of a DQN with heads, in accordance with an embodiment;

FIG. 5 is a flowchart showing example operation of the learning agent of FIG. 2, in accordance with an embodiment;

FIG. 6A is an illustration of an example state of a Gridworld domain, in accordance with an embodiment;

FIG. 6B is an illustration of an example state of a Pong domain, in accordance with an embodiment;

FIG. 7 is a graph of uncertainty of learning episodes over time, in accordance with an embodiment;

FIG. 8A is a graph of discounted rewards in the Gridworld domain, in accordance with an embodiment;

FIG. 8B is a graph of amount of advice used in the Gridworld domain, in accordance with an embodiment;

FIG. 9 is a graph of sum of discounted rewards observed in the Gridworld domain, in accordance with an embodiment;

FIG. 10A is a graph of discounted rewards in the Pong domain, in accordance with an embodiment;

FIG. 10B is a graph of amount of advice used in the Pong domain, in accordance with an embodiment;

FIG. 11 is a graph of sum of discounted rewards observed in the Pong domain, in accordance with an embodiment;

FIG. 12 is a schematic diagram of a learning agent, in accordance with an embodiment; and

FIG. 13 a schematic diagram of a computing device for implementing a learning agent, in accordance with an embodiment.

### DETAILED DESCRIPTION

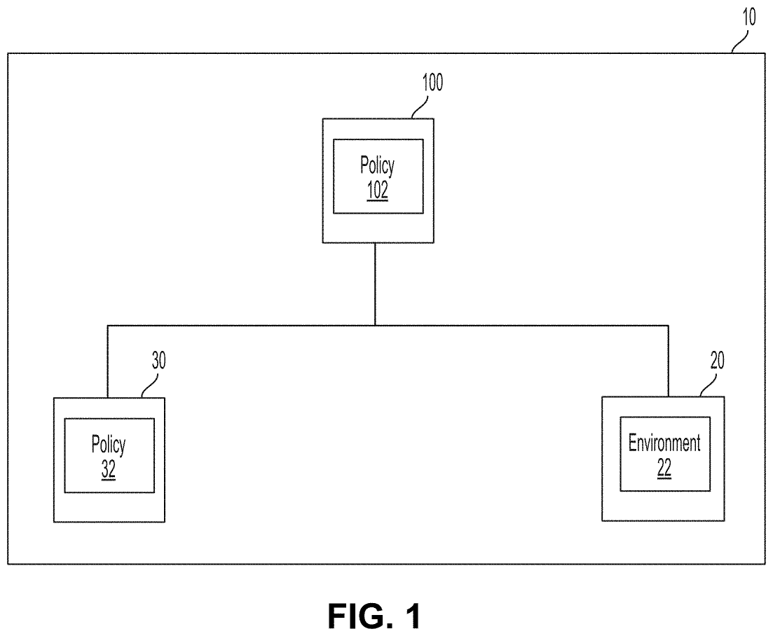

FIG. 1 is a schematic diagram of a training system 10, in accordance with an embodiment. As detailed herein, training system 10 trains a learning agent for operation in a particular environment in manners that allow the agent to obtain advice from one or more demonstrators. Such advice may be obtained by the learning agent, for example, when epistemic uncertainty is high.

As depicted, training system 10 includes an environment provider 20, a demonstrator 30, and a learning agent 100.

Environment provider 20 provides an environment 22 for learning agents (such as learning agent 100) to explore and operate within. Environment 22 may, for example, be a video game, an electronic trading platform for securities (e.g., stocks, bonds, options or other negotiable financial instruments), a vehicle (e.g., automobile, aircraft, etc.) control system, a robotics control system, or the like.

Learning agent 100 is configured to learn how to operate within an environment 22 using reinforcement learning. Accordingly, learning agent 100 may be referred to as a reinforcement learning agent. Operation of learning agent 100 within environment 22 is governed by its policy 102, which provides mappings of states of environment 22 to actions to be taken by learning agent 100. Such a mapping may include, for example, a probability distribution over possible actions.

A demonstrator 30 may be another automated agent such as an agent with more training or different training than learning agent 100. In the depicted embodiment, each demonstrator 30 may maintain its own policy 32. Policy 32 may be more optimal (e.g., more competent) in at least one aspect compared to policy 102. Learning agent 100 may obtain advice from a demonstrator 30 by sampling from policy 32. A demonstrator 30 may also be a human.

As obtaining advice may entail a resource cost or advice may be limited, learning agent 100 is configured to seek advice only in particular circumstances. In the depicted embodiment, learning agent 100 implements a framework that causes learning agent 100 to seek advice when its epistemic uncertainty is high for a certain environment state. This framework may be referred to as Requesting Confidence-Moderated Policy (RCMP).

Conveniently, this framework facilitates training of learning agent 100 when advice is limited or suboptimal. Advice is used by learning agent 100 to assist exploration, which may, for example, improve sample-efficiency. Of note, learning agent 100 does not simply copy a demonstrator's policy.

Learning agent 100 is interconnected with demonstrator 30 and environment provider 20 for electronic communication therebetween. For example, such interconnection could be by way of a communication network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi or WiMAX), SS7 signaling network, fixed line, local area network, wide area network, and others, including any combination of these.

Although one demonstrator 30 is shown in FIG. 1, training system 10 may include any number of demonstrators 30 (e.g., one or more). Similarly, training system 10 may include any number of environment providers 20.

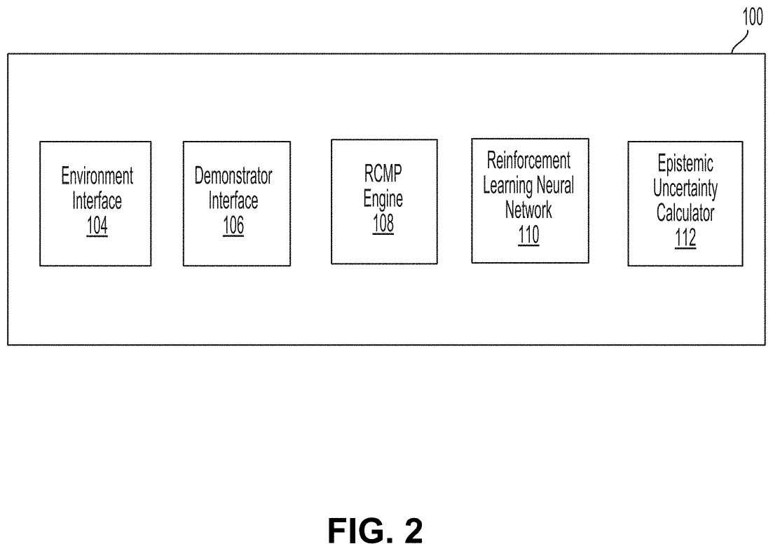

FIG. 2 is a schematic diagram of a learning agent 100, in accordance with an embodiment. As depicted, learning agent 100 includes an environment interface 104, a demonstrator interface 106, an RCMP engine 108, a reinforcement learning neural network 110, and an epistemic uncertainty calculator 112.

Environment interface 104 includes a data interface that allows learning agent 100 to receive environment samples from environment provider 20. Such environment samples include, for example, state data reflective of a state of an environment 22 explored by learning agent 100. Environment interface 104 also allows learning agent 100 to transmit action signals to environment provider 20 and thereby take actions within environment 22.

Demonstrator interface 106 includes a data interface that allows learning agent 100 to send and receive data signals to communicate with one or more demonstrators 30. In one example, learning agent 100 may transmit a signal requesting advice (e.g., a sample from a policy, an action suggestion, or the like) from a demonstrator 30 by way of demonstrator interface 106. In another example, learning agent 100 may receive a signal reflective of advice from a demonstrator 30 by way of demonstrator interface 106.

RCMP engine 108 implements an RCMP framework to govern when learning agent 100 seeks advice from a demonstrator 30. RCMP engine 108 selectively permits a learning agent 100 to obtain advice in situations where the agent's epistemic uncertainty is high. In contrast, when the agent has a low uncertainty, this indicates that the value estimate for the current state is close to convergence, and advice might be saved for more useful situations.

For picturing the situation in which this would be useful, imagine a robot receiving a couple of minutes of advice in an episodic task from a human. Instead of simply sequentially demonstrating the solution of the task multiple times, the human might provide initial demonstrations and let the robot try to solve the task itself. The robot then can ask for advice in states where it has not learned what to do yet, or in new states encountered during the execution. This strategy can result in a better coverage of the advised state space than repeating the demonstration of the solution over and over again.

According to the RCMP framework, a demonstrator 30 π_{Δ}:S×A→[0,1] is available to learning agent 100 and can be queried to give action suggestions (π_{Δ}(s) denotes getting an action sample from π_{Δ} for state s). While demonstrator 30 (π_{Δ}) might follow any algorithm, learning agent 100 requires no knowledge about the internal representation of π_{Δ} and obtains samples of π_{Δ}(s). This framework does not require any demonstrator 30 to have an optimal policy. However, each demonstrator 30 (π_{Δ}) should have a policy that performs significantly better than a random policy.

In the depicted embodiment, a demonstrator 30 might be unavailable at some times, e.g., if the human will be participating in the learning process only for a short period of time. Accordingly, learning agent 100 includes an availability function Aₜ to check whether a particular demonstrator 30 is available at a given step t.

In some embodiments, learning agent 100 has a budget of advice to be used, which may be referred to as an advice budget. This budget may be maintained for a particular demonstrator 30, or a communal budget may be maintained for multiple demonstrators 30. Once the budget is spent (or otherwise depleted), a demonstrator 30 may be unavailable for the remainder of training.

In some embodiments, availability of a demonstrator 30 is evaluated in a domain-specific way, e.g., considering a demonstrator 30 as unavailable when the physically distance between it and learning agent 100 exceeds a threshold, and this obstructs their communication.

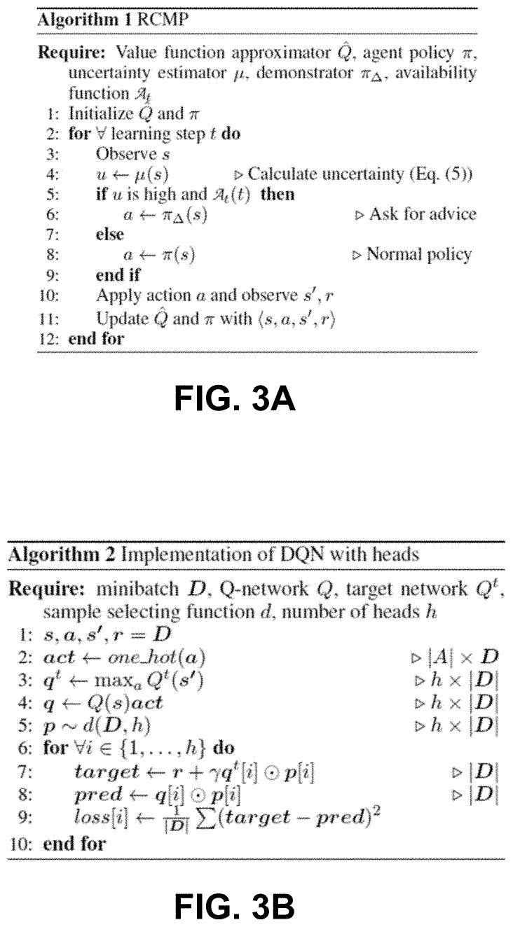

FIG. 3A depicts an example algorithm 1 for implementing the RCMP framework according to one example implementation. Learning agent 100 may use any value-function-based algorithm as long as an epistemic uncertainty measure μ can be estimated from its model of the value function.

Firstly, learning agent 100 initializes the Q-function \hat{Q} (or value function, e.g., for A3C) and the policy π (line 1). Then, for every learning step, learning agent 100 checks its epistemic uncertainty in the current state (line 4) and, in case it is high (e.g., if it exceeds a pre-defined threshold) and a demonstrator 30 is available (line 5), learning agent 100 will ask for an advice and follow the suggested action (line 6). Otherwise, the usual exploration will be applied (line 8). \hat{Q} and π are updated normally according to the chosen learning algorithm.

Also disclosed herein is a method for estimating epistemic uncertainty for model-free RL algorithms. In some embodiments, this measure is used by RCMP engine 108 to determine whether advice should be given in a current state.

Reinforcement learning neural network 110 is a deep neural network for implementing reinforcement learning. The output of reinforcement learning neural network 110 provides policy 102 (FIG. 1) of learning agent 100.

Reinforcement learning enables the solution of Markov Decision Processes (MDP). An MDP is described by a tuple [symbol] S, A, T, R [symbol] . S is the set of states in the system, A is the set of actions available to an agent (e.g., learning agent 100), T:S×A×S→[0,1] is the state transition function, and R:S×A×S→ [symbol] is the reward function. The goal of the learning agent is learning a policy π:S→A that dictates the action to be applied in each possible state, where the optimal policy π* maximizes the expected reward achieved. However, in learning problems the functions T and R are not available to the agent, that can only observe samples of them by actuating in the environment. Therefore, reinforcement learning consists in gathering samples of [symbol] s, a, s′, r [symbol] , where s′=T(s, a) and r=R(s, a, s′). Those samples are the only feedback the agent has for solving the task.

Reinforcement learning algorithms may aim at learning a state-action value function (generally known as Q-function) that approximates the expected return of applying each action in a particular state Q:S×A→ [symbol] . The optimal Q-function is Q*(s, a)=E[Σᵢ₌₀^{∞}γⁱrᵢ], where rᵢ is the reward received after i steps from using action a on state s and following the optimal policy on all subsequent steps, and γ is a discount factor. Q can be used to extract a policy π(s)=argmax_{a∈A}Q(s, a), where using Q* results in π*.

Although classical reinforcement learning algorithms such as Q-Learning and SARSA learn Q* under restrictive conditions, directly applying those algorithms in problems with huge state spaces is usually infeasible. For those problems, function approximators might be able to learn a Q function from which a good policy can be extracted. Deep Q-Network (DQN) leverages deep neural networks to learn Q-functions. The training process of DQNs typically consists of storing the observed samples of interactions with the environment and updating the function approximator with a portion of them, called minibatch D, periodically. The network is optimized by minimizing the following loss function:

$${ℒ}^{D Q N} = {𝔼}_{D} [ {( r + γ {max}_{{a}^{′}} {Q}^{t} ( {s}^{′} , {a}^{′} ) - Q ( s , a ) )}^{2} ] , \qquad Eq . ( 1 )$$

where Q^{t} is a target network that is periodically updated to have the same weights as Q: Q^{t}←Q.

The Asynchronous Advantage Actor-critic (A3C) leverages multiple simultaneous executions of the learning process to learn in a more efficient way. Assuming the task can be executed multiple times in parallel (e.g., in a simulated environment), multiple instances of the learning agent will simultaneously update a locally shared actor-critic Deep Neural Network. The same network will learn the critic (estimate of the value of each state) and the actor (policy). The loss function for the critic is:

[symbol]

^{A3C_critic}= [symbol] ₜ[(Rᵢ−V(sᵢ))²], Eq. (2)

where t is the trajectory of states and rewards observed since the beginning of the episode until the end, Rᵢ=Σₖ₌ᵢ^{k=[t]}γ^{k-i}rₖ is the observed discounted return for this episode, and V(s) is the critic estimate of the network for state s. The actor is then updated according to the estimated advantage function A_{d}, as:

[symbol]

^{A3C_actor}= [symbol] ₜ[−log π(aᵢ|sᵢ)A_{d}(sᵢ)], Eq. (3)

where A_{d}(sᵢ)=Σₖ₌₀^{|t|-1}γ^{k}rᵢ₊ₖ+γ^{|t|}V(s_{|t|})−V(sᵢ). Although effective in some situations, both DQN and A3C have high-sample complexity. However, in some embodiments implementing the RCMP framework, sample-complexity may be reduced.

In the depicted embodiment, reinforcement learning neural network 110 implements a DQN with modifications to facilitate the calculation of epistemic uncertainty, as detailed below.

Epistemic uncertainty calculator 112 calculates an estimate of epistemic uncertainty of learning agent 100 for a given state. Epistemic uncertainty arises from lack of information about the environment a learning agent is trying to model. Epistemic uncertainty can be contrasted from aleatoric uncertainty, which arises from the environment stochasticity.

Value-based algorithms estimate the expected value of applying each action in a given state. However, conventional algorithms cannot estimate the uncertainty on their predictions, which means that the expected values of each action can be compared but there is no direct way of estimating the uncertainty of the predictions.

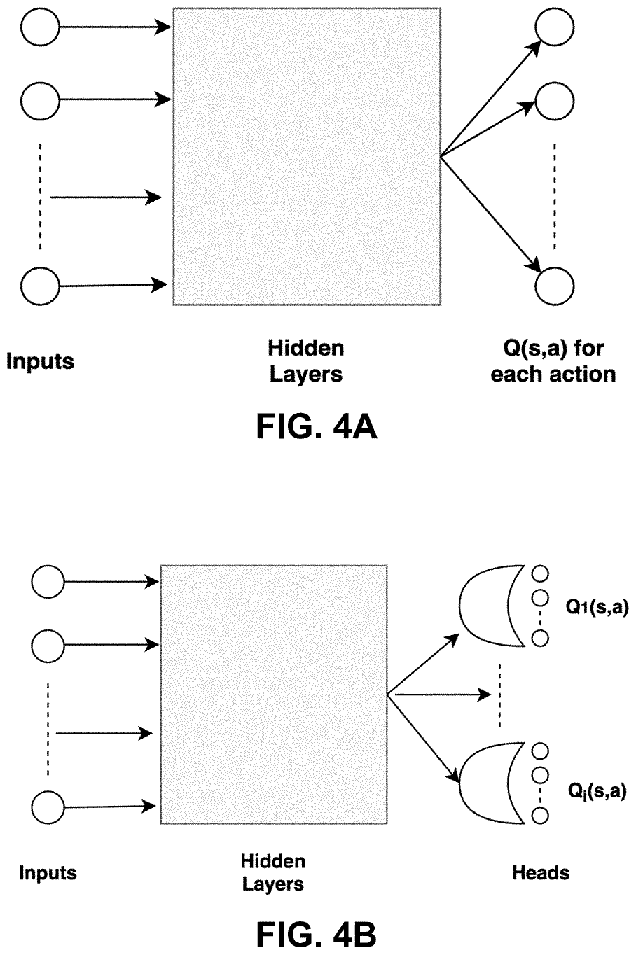

Referring to FIG. 4A, which depicts a DQN network, the first layer includes the state features, whereas the last layer outputs an estimate of the expected value for each action. As shown in FIG. 4B, there is added as a last layer multiple heads estimating separately expected values for each action. Each head estimates a value for each action. Due to the aleatoric nature of the exploration and network initialization, each head will output a different estimate of the action values. As the learning algorithm updates the network weights, their predictions will get progressively closer to the real function, and consequently one close to the others as the variance of the predictions is reduced. Therefore, the variance of the predictions across the heads is used as an estimate of uncertainty for a given state:

$$μ ( s ) = \frac{{Σ}_{∀ a ∈ A} var ( Q ( s , a ) )}{\vert A \vert} , \qquad Eq . ( 4 )$$

where

$$Q ( s , a ) = [ \begin{matrix}{Q}_{1} ( s , a ) \\ ⋮ \\ {Q}_{h} ( s , a )\end{matrix} ] ,$$

Qᵢ(s, a) is the Q-value given by head i for state s and action a, var is the variance, and h is the chosen number of heads. The final value prediction (used, for example, for extracting a policy from the value function) is the average of the predictions given by each head:

$$\hat{Q} ( s , a ) = \frac{{Σ}_{i = 1}^{h} {Q}_{i} ( s , a )}{h} \qquad Eq . ( 5 )$$

Each head will have its own loss function to minimize. For example, the DQN algorithm can be adapted by calculating a loss for each head as:

$${L}_{i}^{D Q N} = {𝔼}_{D} [ {( r + γ {max}_{{a}^{′}} {Q}_{i} ( {s}^{′} , {a}^{′} ) - {Q}_{i} ( s , a ) )}^{2} ] , \qquad Eq . ( 6 )$$

where Lᵢ^{DQN} is the loss function for head i and D is the minibatch for the update.

In another example, the A3C algorithm can be adapted by adding multiple heads for the critic. The loss function for the critic will then be:

Lᵢ^{A3C_critic}= [symbol] ₜ[(Rᵢ−Vᵢ(s))²], Eq. (7)

where Rᵢ has the same definition as in Equation (2) and Vᵢ(s) is the value estimate given by the i-th head. The actor will be updated normally using \hat{V} (as in Equation (6)). The variance in Equation (5) is then computed over the value estimates V(s).

As illustrated in FIG. 4B, the network Q is implemented giving as output a prediction for each action a∈A in each head i∈{1, . . . , h}, given a batch of states s. Therefore, the output of a forward pass in Q is of dimension h×|s|×|A|. A target network Q^{t} may be used for stability. In cases where no target network is used, Q=Q^{t}.

In some embodiments, each head is updated with different samples. This may reduce the bias that might artificially reduce the variance on the predictions. For this purpose, a sample selecting function d: D×h→{0,1}^{h×|D|} may be used, where D is the mini-batch for the current update. This function will sample either 0 (not use) or 1 (use) for each sample and each head. The sample selecting function d may be implemented, for example, by sampling |D|h numbers from {0,1} with a fixed probability. Alternatively, different mini-batches could be sorted for each head. Any suitable network architecture might be used for the hidden layers according to the desired domain of application, as long as the input and output layers are defined as specified.

FIG. 3B shows an algorithm 2 that describes an example implementation of a loss function for DQN, where vectors and matrices are in bold and the comments on the right side depict the dimensionality of the result of each calculation. For a particular minibatch D, the applied actions is converted to the one-hot representation (line 2). Then, the values of the next states are predicted (line 3) and for the observed state-action tuples (line 4). Finally, a loss for each head is calculated, using the sorted samples (line 5) to calculate the predicted and target values (lines 7 and 8). In algorithm 2, ⊙ represents the element-wise multiplication.

In some embodiments, estimating epistemic uncertainty includes learning simultaneously multiple estimates of the value function from a single network. The variance between those estimates is then used as a metric of the epistemic uncertainty, used to define when advice is expected to be useful. Conveniently, the methods of estimating epistemic uncertainty disclosed herein are flexible and applicable to many value-function-based RL algorithms.

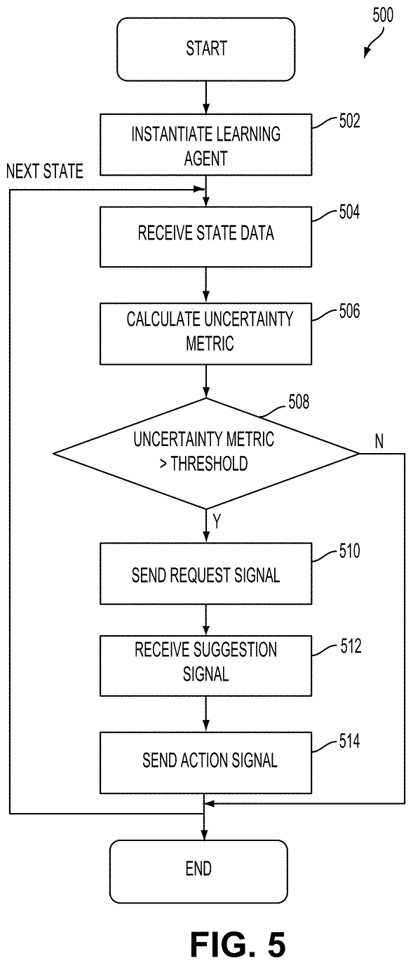

The operation of training system 10 is described with reference to the flowchart depicted in FIG. 5. Training system 10 performs the example operations depicted at blocks 500 and onward, in accordance with an embodiment.

At block 502, learning agent 100 is instantiated, for operation. At this point, learning agent 100 may lack training and lack a competent policy.

At block 504, learning agent 100 receives state data reflective of a state of an environment 22 it is exploring, e.g., by way of a signal from environment provider 20.

At block 506, learning agent 100 calculates an uncertainty metric upon processing the state data, the uncertainty metric measuring epistemic uncertainty of learning agent 100. The calculation of the uncertainty metric may also take into account further state data within training system 10, such as state data reflective of a state of learning agent 100.

At block 508, learning agent 100 compares the uncertainty metric with a pre-defined threshold. Upon determining that the uncertainty metric exceeds this threshold, operation proceeds onward to block 510. Otherwise, learning agent 100 takes action within environment 22 in accordance with its policy 102, without seeking advice from a demonstrator.

At block 510, learning agent 100 request advice from one or more demonstrators 30, e.g. by sending a request signal requesting an action suggestion from a demonstrator 30.

Optionally, before requesting advice from a particular demonstrator 30, learning agent 100 may determine whether the particular demonstrator 30 is available. In one example, learning agent 100 may confirm that a maximum budget has not been used. In another example, learning agent 100 may check a pre-defined schedule to confirm that a human demonstrator is available (e.g., that the current time is within working hours of the human demonstrator).

At block 512, learning agent 100 receives a suggestion signal from a demonstrator 30 reflective of an action suggestion. Learning agent 100 updates its policy 102 based on the action suggestion, e.g., so that it learns from the action suggestion.

At block 514, learning agent 100 takes action within environment 22 to implement the action suggestion, e.g., by sending an action signal to environment provider 20.

Operations at blocks 504 through 514 may be repeated for the next state.

It should be understood that steps of one or more of the blocks depicted in FIG. 5 may be performed in a different sequence or in an interleaved or iterative manner. Further, variations of the steps, omission or substitution of various steps, or additional steps may be considered.

Learning from Demonstrations and Action Advice

Existing methods of leveraging available policies can be divided into two paradigms. The first paradigm, Learning from Demonstrations (LfD), typically has a human providing demonstrations to a learning agent. Advice usually covers entire episodes, and in general the learning agents try to model the demonstrated policy in a supervised learning fashion, being unable to improve the demonstrator's policy via exploration.

The second paradigm, Action Advising consists of receiving action advice for a single state where it is expected to be useful (ideally states that the agent has not explored before and that have a high difference in expected returns for different actions). One often-used metrics for defining when to give advice is the importance advising metric:

$$I ( s ) = {max}_{a ∈ A} {Q}_{𝒟 ( s , a )} - {min}_{a ∈ A} {Q}_{𝒟 ( s , a )} , \qquad Eq . ( 8 )$$

where [symbol] is the Q-table of the demonstrator (a RL demonstrator is usually assumed). The intent of this metric is to give advice when there is a huge difference between the best and worst actions. Although effective in some scenarios, decisions are taken through the point of view of the demonstrator. This has two undesired consequences: (i) the advising-function does not consider the learning agent's policy, which means that advice is possibly given in states where the agent has had sufficient experiences, while neglecting new states for the learning agent; (ii) the demonstrator has to observe the learning agent during all time steps, increasing data processing burden.

Further, neither of these two paradigms take into account that availability of advice may be limited, e.g., either a human demonstrator is available only for a short period of time or communication costs may impose limitations on quantity or frequency of advice from demonstrators that are other automated agents.

### Empirical Evaluation

Embodiments of training system 10 implementing the RCMP framework were evaluated in two domains varying (i) learning algorithms; (ii) competency level of the demonstrators; and (iii) domain complexity. The first domain is a relatively simple Gridworld-like domain where the optimal policy can be defined can be used as a demonstrator for a DQN-based agent. The second domain is the Pong Atari game, a more complex domain where the demonstrator is a previously-trained A3C-based agent. For each domain, four methods of using advice were evaluated:

RCMP: Implementation of RCMP as described herein.

No Advice: A baseline learning with no advice.

Random: Learning agent receives uniformly random advice with no regard to its uncertainty.

Importance: Advice is given according to the importance advising metric calculated from the Q-function of a trained agent (Eq. (8)), as in previous action advising literature. This algorithm is more restrictive than RCMP because: (i) the demonstrator needs a Q-function; (ii) the learning agents needs to be observed at all time steps, while for RCMP the agent monitors its own uncertainty and queries the demonstrator only when needed.

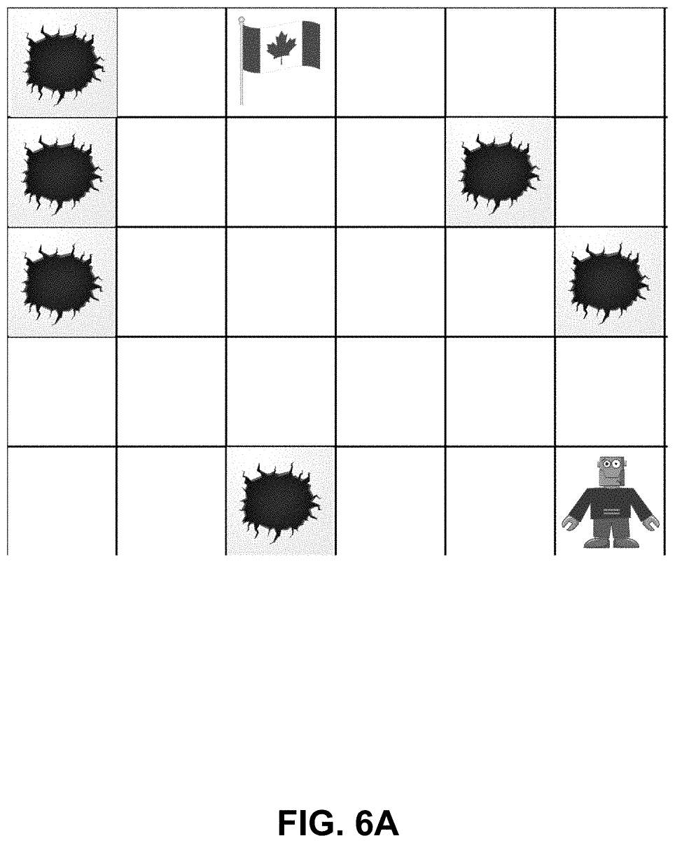

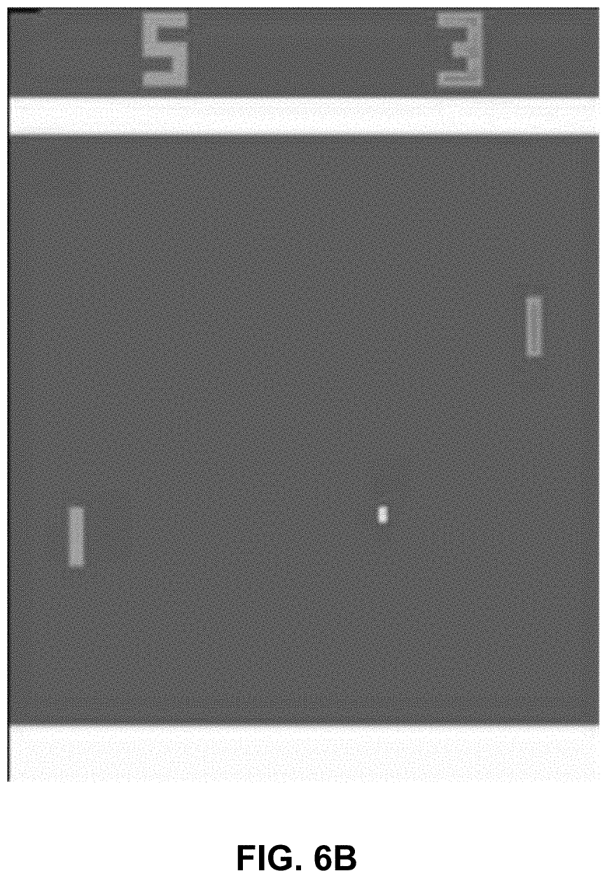

FIG. 6A illustrates an initial state of an example Gridworld domain. A learning agent aims to reach a goal as quickly as possible, while avoiding falling in one of the holes spread in the environment. The agent has 4 actions A={up, down, left, right} that most of the times have the intended effect, unless the agent is in the 4-neighborhood of a hole. In that case, the agent has a 25% probability of falling into the hole regardless of the applied action. An episode ends when the agent has either reached the goal or fallen into a hole. In the former case, a reward of +1 is awarded, whereas in the latter the reward is −1.

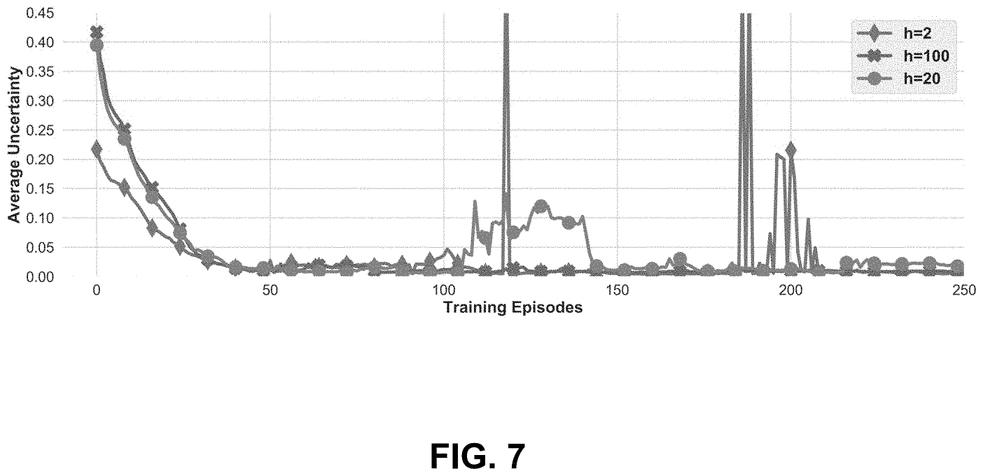

This domain is also used for analyzing the effect of the number of heads h on the uncertainty estimate. FIG. 7 shows the average uncertainty (over 200 repetitions) observed in each learning episode over time for different configurations of the parameters. Regardless of the chosen parameter value the estimate works as expected. At first the uncertainty is high, then it gets progressively lower as the agent trains for longer. However, if the number of heads is very low (h=2), sudden spikes in the uncertainty might be observed when the agent encounters new situations (e.g., around after 120 and 200 learning episodes). The uncertainty curve tends to become smoother for higher number of heads, as shown in the smooth curve of h=100. However, adding more heads means adding parameters to be trained for each head, hence a trade-off is desired.

For evaluating the learning performance in this domain, DQN is used as the base learning algorithm and the optimal policy as the demonstrator. All algorithms are trained for 1000 episodes in total, where the agents are evaluated (exploration and updates turned off) for 10 episodes at every 10 learning episodes. The maximum number of demonstrated steps is set to 700 for the algorithms that can receive advice. For all algorithms, α=0.01, h=5, and γ=0.9 The network architecture is composed of 2 fully-connected hidden layers of 25 neurons each before the layer with the heads.

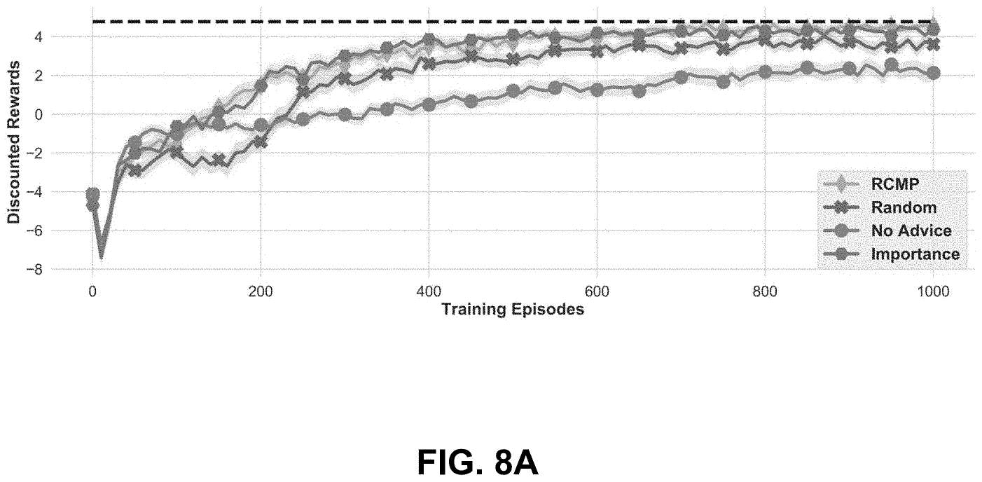

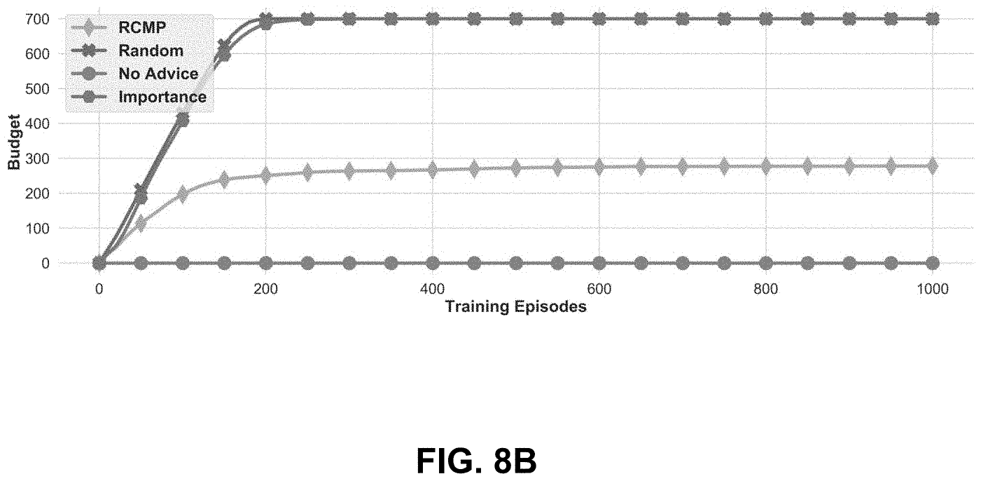

FIG. 8A shows the performance in observed discounted reward for each algorithm, while FIG. 8B shows the amount of advice used in 200 repetitions of the Gridworld experiment. The shaded area corresponds to the 90% confidence interval. The dashed line corresponds to the optimal performance. RCMP asks for advice until around 200 learning steps, after which the algorithm already has high confidence on its predictions and stop asking for advice. Both Random and Importance, on their turn, keep asking for advice until the maximum budget is used. RCMP achieves better performance than both Random and No Advice and the ties with Importance for the best performance, while using less advice among all the advice-based algorithms. Notably, RCMP does not use the maximum budget, stopping to ask for advice when it is not expected to be useful anymore, while Importance and Random spend all the available advice regardless of how fast the learning agent converges. In all cases, the use of advice helped converging faster towards the optimal policy than No Advice. After 1000 episodes, No Advice still has not converged to the same performance as the algorithms making use of advice.

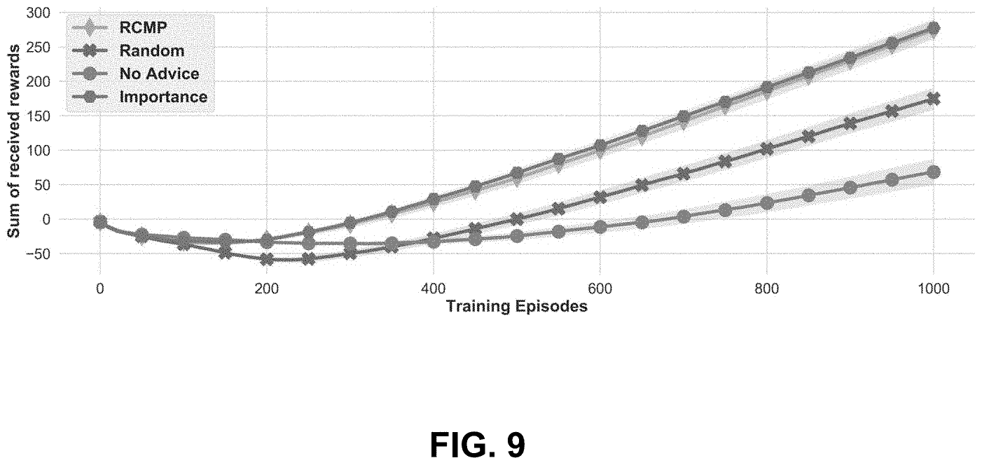

FIG. 9 shows the accumulated reward achieved by each algorithm throughout the entire evaluation. More specifically, FIG. 9 shows the sum of discounted rewards observed in 200 repetitions of the Gridworld experiment. The shaded area corresponds to the 90% confidence interval. In this experiment, RCMP performed better than both No Advice and Random and tied for the best performance with Importance, while using less advice than all other advice-based algorithms.

FIG. 5B illustrates an example Pong domain. This two-dimensional game consists of controlling an in-game paddle by moving it across the screen to hit a ball towards the opposing side. The learning agent competes against a fixed-strategy opponent. An episode lasts 21 goals, in which a reward of +1 is awarded to the player that scores the goal and −1 is given to the other player. Pong is a much harder problem to solve, as the game input consists simply of the game screenshot and winning the game requires a sequence of carefully chosen actions.

For this domain, A3C is used as the base learning algorithm. An A3C agent is trained until it is able to achieve a score of +21 in an episode and use it as the demonstrator. All algorithms are trained for 3 million steps, where an evaluation phase of 1 episode is carried out after each 30,000 learning steps. For all algorithms, α=0.0001, h=5, and γ=0.99. The network architecture is composed of 4 sequences of Convolutional layers followed by max pooling layers, connected to the critic head and actor layers that are fully-connected. Following those layers, a Long Short-Term Memory (LSTM) layer is added which is connected to the critic heads and actor outputs

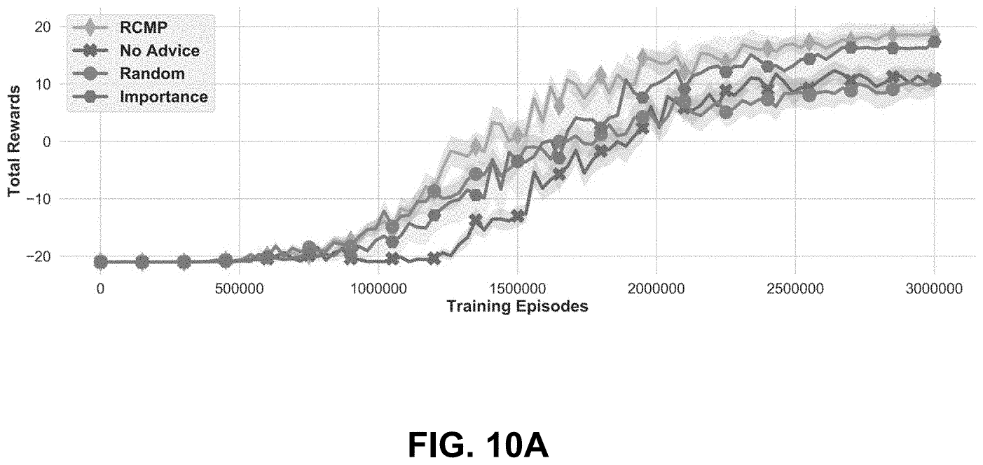

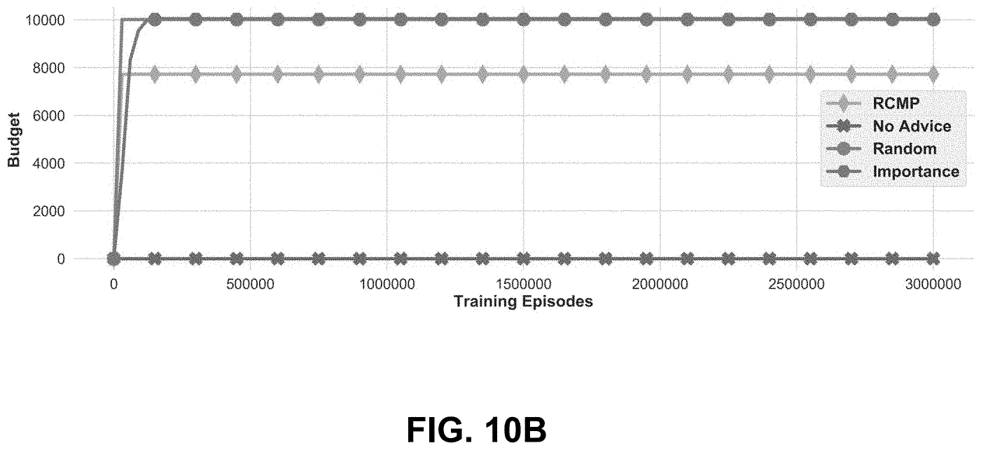

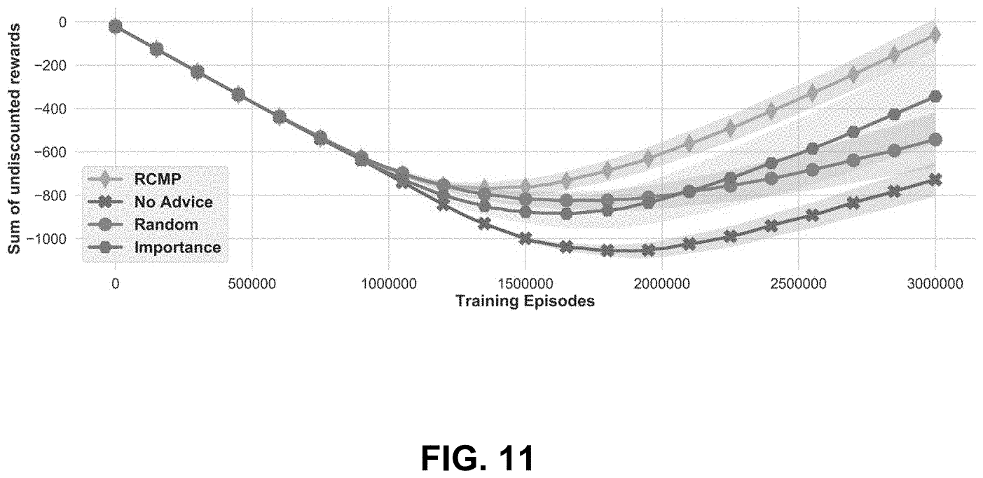

FIG. 10A and FIG. 10B show, respectively, the undiscounted reward achieved by each algorithm and the amount of received advice. More specifically, FIG. 10B shows the amount of advice used in 20 repetitions of the Pong experiment. The shaded area corresponds to the 60% confidence interval. RCMP starts to show performance improvements over No Advice roughly around after 1,000,000 learning steps. The apparent disconnect between when the agents receive advice and when the improvement happens is because a sequence of actions must be learned before an improvement in score is seen. Although all advice-based algorithms are getting closer to a winning behavior as they receive advice, seeing an improvement in score takes longer. While Random and Importance quickly spends all the available advice, RCMP asks for advice only for a short period of time, after which the uncertainty is not high enough to ask for it anymore. Although the pattern in advice use and improvement over No Advice is the same as for the Gridworld domain for all algorithms, here RCMP presents clear improvements over all the other algorithms while receiving less advice (more visible in FIG. 11, which shows the sum of undiscounted rewards observed in 20 repetitions of the Pong experiment).

Based on the empirical results, RCMP as implemented in evaluated embodiments performs better in certain respects than regular learning, randomly receiving advice, and importance advising across domains of different complexity levels. Further, receiving advice based on epistemic uncertainty may be advantageous both when the demonstrator is optimal (e.g., Gridworld) or when the demonstrator is a trained agent with no optimality guaranteed (e.g., Pong).

In some embodiments, the need for exploration (which makes reinforcement learning potentially costly and/or dangerous for certain applications) is reduced. This is especially convenient at the beginning of learning when an agent is acting more randomly.

In some embodiments, advice from a demonstrator 30 is leveraged to accelerate the learning process, while allowing a learning agent 100 to explore the environment and improve upon the demonstrator's policy.

In some embodiments, advice from a demonstrator is sought in situations in which a learning agent 100 has high uncertainty and is not sought otherwise, e.g., when the agent does not need it. In this way, learning efficiency (e.g., sample efficiency) may be improved, e.g., by reducing the amount of data to be transmitted between the learning agent 100 and demonstrators 30, and by reducing unnecessary processing of advice by a learning agent 100.

In some embodiments, a learning agent 100 may utilize policy-based reinforcement learning, value-based reinforcement learning, model-based reinforcement learning, or a combination thereof.

In some embodiments, a learning agent 100 may seek advice from various types of demonstrators. In some embodiments, learning agent 100 seeks advice from a demonstrator that is a human. In other embodiments, learning agent 100 seeks advice from a demonstrator that is another automated agent (e.g., a agent with more training or different training). In some embodiments, learning agent 100 seeks advice from a demonstrator with actions (and advice) defined by one or more heuristics.

In some embodiments, learning agent 100 seeks advice from a committee of demonstrators. The committee of demonstrators can vote on the advice to be provided to learning agent 100. The votes can be weighted, e.g., based on the quality of advice expected from each demonstrator or other factors.

In some embodiments, learning agent 100 is adapted to perform actions in an environment that is a trading venue. In such embodiments, the action and action suggestions described herein relate to trading actions (e.g., buying or selling) with respect to securities. So, learning agent 100 may be trained to function as a automated trading agent.

In some embodiments, an advice budget may be provided at the beginning of an episode. In some embodiments, an advice budget may be split into portions, with portions provided at successive parts of an episode (e.g., after a certain number of time steps). In some embodiments, a learning agent 100 may be configured to use its advice budget based on an estimate of a time horizon, e.g., how long training is expected or how long an episode is expected to last. The estimate of a time horizon may, for example, take into account the current level of epistemic uncertainty of learning agent 100.

In some embodiments, a demonstrator 30 receives state data (including for example, state data of environment 22 and learning agent 100), and calculates epistemic uncertainty of the learning agent 100. In such embodiments, demonstrator 30 determines when the epistemic uncertainty is high (e.g., exceeding a pre-defined threshold), and sends advice to learning agent 100 in such situations. In such embodiments, demonstrator 30 manages an advice budget for itself. The advice budget may be shared between multiple learning agents 100.

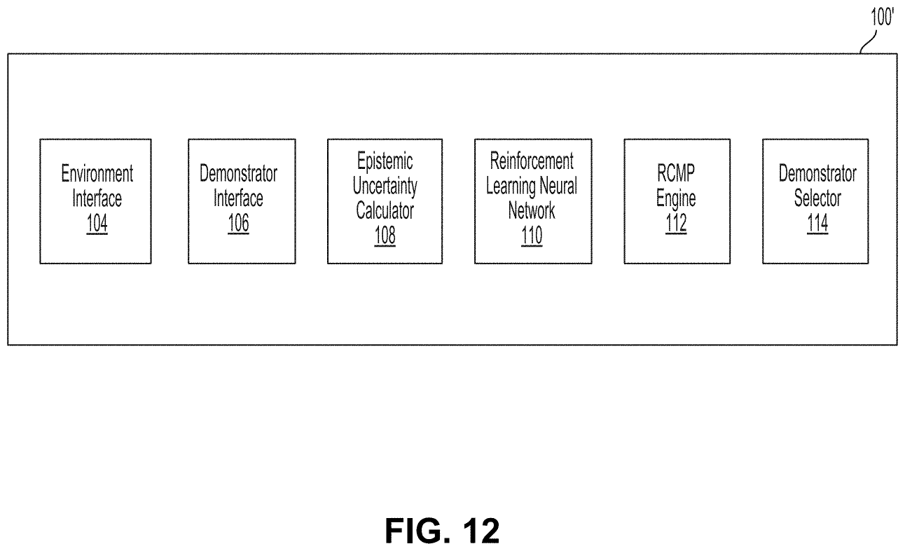

FIG. 12 is a schematic diagram of a learning agent 100′, in accordance with an embodiment. In this embodiment, learning agent 100′ includes a demonstrator selector 114 for allowing learning agent 100′ to select from among a plurality of demonstrators 30, e.g., to obtain advice from one or more selected demonstrators 30 when the agent's epistemic uncertainty is high. Learning agent 100′ is otherwise substantially similar to learning agent 100.

Demonstrator selector 114 maintains data reflecting one or more characteristics of demonstrators 30. In the depicted embodiment, such characteristics include a measure of the risk-affinity of each demonstrator 30 according to its policy 32. Demonstrator selector 114 processes state data regarding environment 22 to determine where learning agent 100′ is located within environment 22 (e.g., a location in a spatial dimension and/or temporal dimension).

Demonstrator selector 114 selects from among demonstrators 30 based the one or more characteristics, and based on the location of learning agent 100′ within environment 22. In one example, demonstrator selector 114 may select a more risk-tolerant demonstrator 30 when learning agent 100′ is at a location in environment 22 associated with an earlier stage of an episode. Conversely, in this example, demonstrator selector 114 may select a more risk-adverse demonstrator 30 when learning agent 100′ is at a location in environment 22 associated with a later stage of an episode.

In some embodiments, the characteristics of demonstrators 30 maintained by demonstrator selector 114 include a characteristic reflecting an expected quality of advice. The quality of advice may be estimated for environment locations generally or for specific environment locations. In such embodiments, demonstrator selector 114 selects a demonstrator 30 based on at least the expected advice quality.

In some embodiments, each demonstrator 30 may have a different cost or a different budget for advice. For example, among the plurality of demonstrator 30, a human demonstrator may have a higher cost (or smaller budget) than an automated agent demonstrator. In such embodiments, demonstrator selector 114 selects a demonstrator 30 based at least on the particular cost or budget associated with each demonstrator 30.

In some embodiments, demonstrator select 114 selects a demonstrator 30 based on a combination of factors, e.g., by balancing cost of advice against quality of advice.

In some embodiments, learning agent 100′ functions as an automated trading agent. In such embodiments, the characteristics of demonstrators maintained by demonstrator selector 114 include a measure of a level of aggression of each demonstrator 30 according to its policy 32. For example, the level of aggression may reflect the propensity of demonstrator 30 to take certain actions. For example, a low level of aggression may be attributed to an action that does nothing while a high level of aggression may be attributed to a buy action that crosses the spread. In such embodiments, demonstrator select 114 selects a demonstrator 30 based on at least on its level of aggression.

In some embodiments, demonstrator selector 114 ranks demonstrators 30 based on its selection criterion (or criteria) and then determines the availability of demonstrators 30. Demonstrator selector 114 selects the highest ranked demonstrator 30 that is available to provide advice.

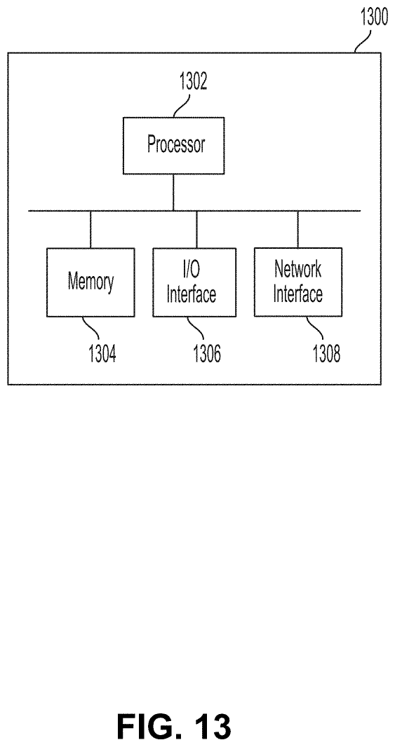

FIG. 13 is a schematic diagram of a computing device 1300 for implementing a learning agent 100 (or a learning agent 100′), in accordance with an embodiment. As depicted, computing device 1300 includes one or more processors 1302, memory 1304, one or more I/O interfaces 1306, and, optionally, one or more network interface 1308.

Each processor 1302 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1304 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1304 may store code executable at processor 1302, which causes device 1300 to implement the functionality of automated agents 130, as disclosed herein.

Each I/O interface 1306 enables computing device 1300 to interconnect with one or more input devices, such as a keyboard, mouse, VR controller, camera, touch screen and a microphone, or with one or more output devices such as a display screen and a speaker.

Each network interface 1308 enables computing device 1300 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The methods disclosed herein may be implemented using a system that includes multiple computing devices 1300. The computing devices 1300 may be the same or different types of devices. Each computing devices may be connected in various ways including directly coupled, indirectly coupled via a network, and distributed over a wide geographic area and connected via a network (which may be referred to as “cloud computing”).

In some embodiments, one or more computing devices 1300 may be used to implement an environment provider 20 or a demonstrator 30.

For example, and without limitation, each computing device 1300 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A computer-implemented system for training a learning agent, the system comprising:
at least one processor;
memory in communication with the at least one processor, and
software code stored in the memory, which when executed by the at least one processor causes the system to:
instantiate a learning agent that maintains a reinforcement learning neural network;
receive state data reflective of a state of an environment explored by the learning agent;
calculate an uncertainty metric upon processing the state data, the uncertainty metric measuring epistemic uncertainty of the learning agent;
upon determining that the uncertainty metric exceeds a pre-defined threshold:
send a request signal requesting an action suggestion from a demonstrator;
receive a suggestion signal reflective of the action suggestion; and
send an action signal to implement the action suggestion.

2. The computer-implemented system of claim 1, wherein the demonstrator comprises an automated agent.

3. The computer-implemented system of claim 2, wherein the automated agent has a policy that differs from a policy of the learning agent.

4. The computer-implemented system of claim 1, wherein the demonstrator comprises a human.

5. The computer-implemented system of claim 1, wherein the reinforcement learning neural network comprises a plurality of hidden layers including a layer having a plurality of heads, each of the heads for generating predictions of action values for actions that can taken by the learning agent.

6. The computer-implemented system of claim 1, wherein the environment is an electronic trading platform.

7. The computer-implemented system of claim 1, further comprising a network communication interface for transmitting signals through a network, and the request signal is sent by way of the network communication interface.

8. The computer-implemented system of claim 7, wherein the action signal is sent by way of the network communication interface.

9. A computer-implemented method for training a learning agent, the method comprising:
instantiating a learning agent that maintains a reinforcement learning neural network;
receiving state data reflective of a state of an environment explored by the learning agent;
calculating an uncertainty metric upon processing the state data, the uncertainty metric measuring epistemic uncertainty of the learning agent;
upon determining that the uncertainty metric exceeds a pre-defined threshold:
sending a request signal requesting an action suggestion from a demonstrator;
receiving a suggestion signal reflective of the action suggestion; and
sending an action signal to implement the action suggestion.

10. The computer-implemented method of claim 9, wherein the reinforcement learning neural network comprises a plurality of hidden layers including a layer having a plurality of heads, each of the heads for generating predictions of action values for actions that can taken by the learning agent.

11. The computer-implemented method of claim 10, wherein the calculating the uncertainty metric comprises:
receiving, from each of the plurality of heads, a predicted action value; and
computing a variance of the predicted action values received from the plurality of heads.

12. The computer-implemented method of claim 10, wherein each of the plurality heads minimizes a loss function associated with that head.

13. The computer-implemented method of claim 9, further comprising determining whether the demonstrator is available.

14. The computer-implemented method of claim 13, further comprising maintaining an advice budget for the demonstrator and the determining comprises determining whether the advice budget is depleted.

15. The computer-implemented method of claim 9, further comprising selecting the demonstrator from among a plurality of demonstrators.

16. The computer-implemented method of claim 9, wherein the demonstrator comprises an automated agent.

17. The computer-implemented method of claim 16, wherein the automated agent has a policy that differs from a policy of the learning agent.

18. The computer-implemented method of claim 9, wherein the demonstrator comprises a human.

19. The computer-implemented method of claim 9, further comprising updating a policy of the learning agent based on the action suggestion.

20. A computer-implemented method for determining epistemic uncertainty of a learning agent, the method comprising:
maintaining a neural network comprising a plurality of hidden layers including a layer having a plurality of heads, each of the heads generating predictions of action values for actions that can taken by the learning agent;
for a given state of an environment explored by the learning agent:
receiving, from each of the plurality of heads, a predicted action value; and
computing a variance of the predicted action values received from the plurality of heads.
